(19) United States
(12) Patent Application Publication
(10) Pub. No.: US 2013/0153125 A1
(43) Pub. Date: Jun. 20, 2013

(54) JOINING SHEETS TO FORM A BELT

(71) Applicants: Jeffrey A. Trest, Pittsford, NY (US); Kimberly W. Standish, Palmyra, NY (US); Mark C. Zaretsky, Rochester, NY (US)

(72) Inventors: Jeffrey A. Trest, Pittsford, NY (US); Kimberly W. Standish, Palmyra, NY (US); Mark C. Zaretsky, Rochester, NY (US)

(21) Appl. No.: 13/329,547

(22) Filed: Dec. 19, 2011

(51) Int. Cl. B32B 37/06; B32B 37/10

(52) U.S. Cl. 156/157

(57) ABSTRACT

A method for joining a first sheet (10) to a second sheet (11) includes providing a first rigid plate (6); providing a gas absorbing layer on the first rigid plate; positioning the first sheet, the first sheet has at least a first layer (52) and a second layer (54), on the gas absorbing layer (8); positioning the second sheet, wherein the second sheet has at least a first layer and a second layer, on the gas absorbing layer; wherein an edge of the of the first sheet abuts an edge of the second sheet; placing a second rigid plate on top of the first and second sheet; wherein the second rigid plate is transparent; applying pressure to the first sheet edge and second sheet edge; and laser welding the edge of the first sheet to the edge of the second sheet with a first laser through the second rigid plate.

### CROSS REFERENCE TO RELATED APPLICATIONS

Reference is made to commonly-assigned copending U.S. patent application Ser. No. ________ (Attorney Docket No. K000773USO1NAB), filed herewith, entitled SYSTEM FOR JOINING SHEETS TO FORM A BELT, by Trest et al.; the disclosure of which is incorporated herein.

### FIELD OF THE INVENTION

The invention is for joining two sheets having at least two layers and in particular to forming a belt for an electrophotographic printer.

### BACKGROUND OF THE INVENTION

Electrophotographic (EP) printers use belts as process members for a variety of applications, such as an intermediate transfer belt or a fuser belt. The use of a belt rather than a roller or drum provides several advantages including replacement part cost, geometry flexibility, and space allocation. One example of such a belt is an intermediate transfer web, used to accumulate color separations in an EP printer. Another example is a fuser belt, used to melt and flow the toner image. Yet another example is a photoreceptor belt, used in the creation of a latent electrostatic image.

It is highly desirable to have either a truly seamless belt or a seamed belt that provides the same functionality in the seamed area as the unseamed area. A belt having this characteristic does not impose any limits on productivity and may have an extended life in contrast to a seamed belt with the characteristic that the seamed area is not functional and must be avoided.

Methods of manufacturing a seamless belt include processes such as centrifugal casting or extrusion through a circular die. However, these processes typically produce a single belt per run, resulting in a higher cost per part. Furthermore, as the belt circumference increases, the manufacturing equipment cost increases non-linearly, adding significantly to the belt cost. Finally, it may be desirable to produce a belt having a multi-layered structure, adding further significant cost in a single belt per run manufacturing process. An example of a multi-layered belt is a compliant intermediate transfer belt consisting of a high modulus, rigid support layer, a lower modulus elastomeric compliant layer, and a higher modulus, low surface energy release layer.

A method of manufacturing a lower cost seamed belt begins with a roll of the material to be formed into a belt, either single layer or multi-layer in composition, from which a desired length of the material is cut. The two ends of this cut length are then joined to form a seam, creating an endless loop or a belt. There are a variety of methods that may be used to form a seam, including taping and ultrasonic welding. However, these methods typically result in a belt having a physical or electrical or thermal variation at the seam that renders the seam region functionally unusable, thereby negatively impacting process productivity and belt life.

Other attempts to solve this have met with varied success. U.S. Pat. No. 7,318,878 (Link) discloses forming continuous belts by butting ends of a thermoplastic film together, holding them under pressure, and heating them by radiation from a laser. This method produces a seam region that is as functional as the unseamed region of the belt, thereby creating a functionally seamless belt. This method, however, does not discuss the possibility of laser welding multilayer films. In particular, this method does not discuss the problem of outgassing when trying to laser weld a thermoplastic film having a thermoplastic polyurethane layer.

### SUMMARY OF THE INVENTION

Briefly, according to one aspect of the present invention a method for joining a first sheet to a second sheet includes providing a first rigid plate; providing a gas absorbing layer on the first rigid plate; positioning the first sheet, wherein the first sheet has at least a first layer and a second layer, on the gas absorbing layer; positioning the second sheet, wherein the second sheet has at least a first layer and a second layer, on the gas absorbing layer; wherein an edge of the first sheet abuts an edge of the second sheet; placing a second rigid plate on top of the first and second sheet; wherein the second rigid plate is transparent; applying pressure to the first sheet and second sheet; and laser welding the edge of the first sheet to the edge of the second sheet with a first laser through the second rigid plate.

The invention and its objects and advantages will become more apparent in the detailed description of the preferred embodiment presented below.

### BRIEF DESCRIPTION OF THE DRAWINGS

FIG. 1 is a cross-sectional profile of the laser welding fixture including the two sheets to be welded.

FIG. 2A shows the two sheets to be welded prior to contact.

FIG. 2B shows the two sheets to be welded in contact prior to welding.

FIG. 2C shows the two sheets after welding.

FIG. 3 shows an endless loop formed with the laser welded butt seam of the present invention.

FIG. 4 is a cross-sectional profile of the laser welding fixture including the two sheets to be welded and a separate laser absorbing layer.

The attached drawings are for purposes of illustration and are not necessarily to scale.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

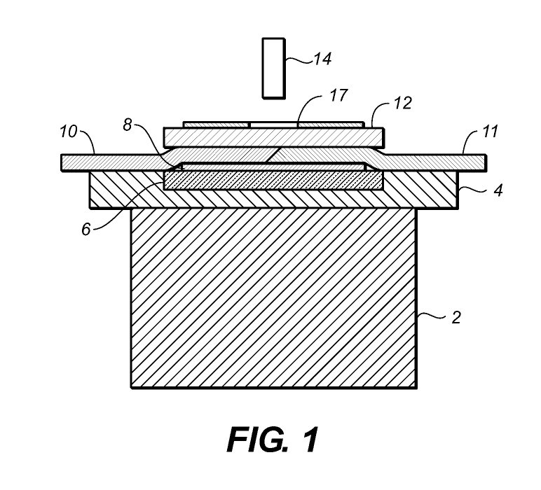

Referring now to FIG. 1, a support 4 is shown holding a first rigid plate 6. In one embodiment, the support 4 is comprised of a block of aluminum and the first rigid plate 6 is comprised of glass and resting in a trough cut into support 4. The first rigid plate 6 should be thick and stiff enough to withstand the clamping pressure applied by load application device 2, and optically flat to provide an extremely flat surface for uniform clamping between the first and second rigid plates, 6 and 12.

On the other side of first rigid plate 6, a gas absorbing layer 8 such as a 118 micrometer thick sheet of polyethylene terephthalate (PET) is provided. First sheet 10 and second sheet 11 are placed on the other side of gas absorbing layer 8. The two sheets 10 and 11 are placed with their ends pressed together. Sheets 10 and 11, are held in place by a vacuum applied to each sheet. These sheets and their contact geometry will be described further in a subsequent section.

A second rigid plate 12 is placed on the two sheets 10 and 11. In addition to the properties described above for first rigid plate 6, this second rigid plate 12 should also be non-absorbing at the operating wavelength of laser 14.

All the material layers are clamped together with pressure applied between load application device 2 and an upper supporting frame not shown. A load range of between 20 and 95 psi was used. One embodiment of load application device 2 is a pneumatic piston. Another is a hydraulic piston.

A laser 14, in one embodiment represented by a multi-channel diode device, is positioned over second rigid plate 12. Through second rigid plate 12 laser 14 supplies energy to sheets 10 and 11 to be welded. This energy is converted into heat and creates the welded seam. The seam to be welded is flanked by aperture 17 placed on top of second rigid plate 12 with its open area straddling the contact region formed by the two sheets to be welded. Aperture 17 is held in place by various means such as taping or by using more sophisticated methods such as vacuum hold down. The opening of aperture 17 ranges between 0.25 and 0.375 inches in width and serves to concentrate the heat at both sides of the seam and at the seam's center. The aperture may be created by using any material that is opaque to the laser operational wavelength.

One material for support 4 is aluminum, but any non-deformable flat rigid material may be used such as a metal or metal compound like steel, stainless steel, iron, and non-ferrous metals as well as compounds such as aluminum, and aluminum alloys, nickel and its alloys, magnesium and its alloys etc.

One material for rigid plates 6 and 12 is glass but alternative materials that may be suitable include different types of low thermal conducting materials with high melting temperatures such as quartz, borosilicate, fumed silica or other types of glass, as well as dielectric ceramics.

One material for gas absorbing layer 8 is polyethylene terephthalate (PET) but other materials capable of handling high heat without distortion combined with low thermal conductivity may be used such as polyimide or polycarbonate.

One example for laser 14 is a single laser source irradiating sheets 50 and 60. Another example for laser 14 is a single laser source distributed through plurality of radiation conducting fibers so as to enable a controllable profile of laser energy to be applied to sheets 50 and 60. Yet another example for laser 14 is a laser diode array.

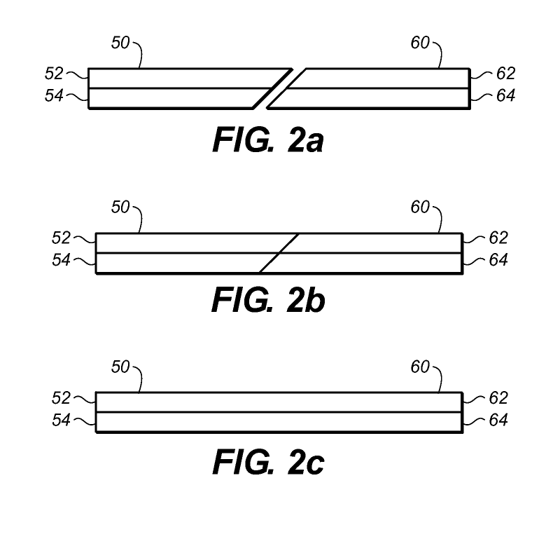

Referring to FIG. 2A, displaying the sheets to be welded before contact, first layer 52 and second layer 54 form a first sheet 50 to be joined with second sheet 60, similarly constructed with first layer 62 and second layer 64. The edges of first sheet 50 and second sheet 60 are cut at a 45 degree angle. Other angles up to 90 degrees can be used but the 45 degree angle resulted in the strongest bond, 42.4 pounds per lineal inch, equal to or greater than the bulk strength of the belt material. FIG. 2B shows the sheets in alignment ready for welding comprised of sheets 50 and 60 consisting of layers 52 and 54 as well as 62 and 64. FIG. 2C shows the welded structure where sheets 50 and 60 made-up of elements 52 and 54 and 62 and 64 are all one piece with no discernable seam. In this embodiment it is important that layers 52 and 62 have the property of being able to absorb in the operational wavelength of the laser and convert that absorbed energy into heat, such as is provided by the carbon addenda in a carbon-loaded polycarbonate material.

Examples of materials suitable for layers 52 and 62 include a wide variety of thermoplastics such as polycarbonate, polyimide, polyamide, PET, PEN, PETG, provided these thermoplastics either have a material within the thermoplastic that absorbs the laser energy and converts at least some of the absorbed energy into heat. Examples of such added materials include carbon or other infrared absorbing dyes or pigments.

Examples of materials suitable for layers 54 and 64 include a wide variety of thermoplastic elastomers such as polyurethanes, styrenic block copolymers (e.g. Kratons), and EPDM.

Sheets 50 and 60 may be composed of more than two layers. For example, a third layer may be coated or otherwise deposited onto layers 54 and 64 to serve as a release layer for improved toner transfer for an intermediate transfer belt. An example of such a release layer is a ceramer.

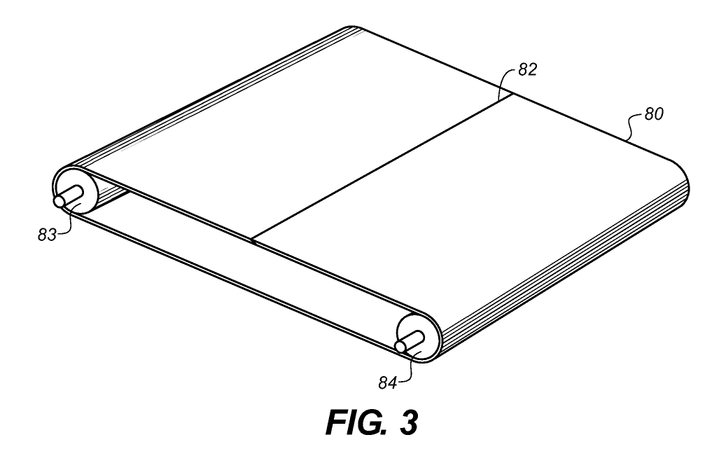

FIG. 3 depicts the endless belt 80 with seam 82. The seam 82 is flat with a minimum amount of distortion that is removed when the belt is placed under slight tension around rollers 83 and 84.

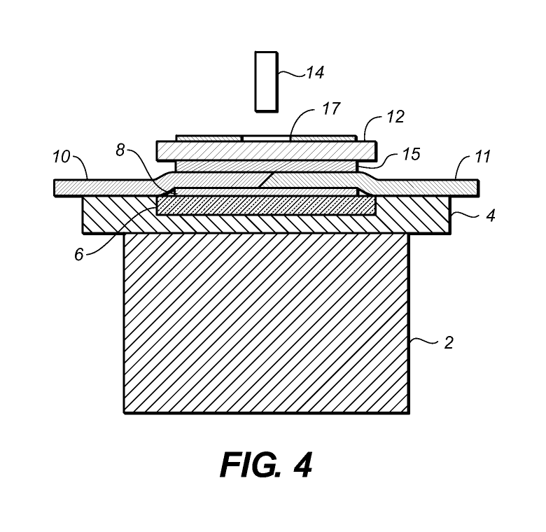

FIG. 4 depicts another embodiment of the invention, differing from the embodiment shown in FIG. 1 in that the property of absorbing the laser energy and converting it to heat is supplied by a layer of material that is separate from the two sheets to be welded. This removes the need to provide the laser absorbing energy property in the material to be welded into a belt, thereby enabling the use of a wider range of materials for the belt composition. In this embodiment, a laser energy absorbing material 15 is provided between second rigid plate 12 and first and second sheets 10 and 11.

In yet another embodiment, in addition to the first laser welding the edges of the first and second sheet through the second rigid plate, a second laser welds the edge of the first sheet to the edge of the second sheet through the first rigid plate and gas adsorbing layer, with the first rigid plate and gas adsorbing layer now having the additional property of being transparent to the second laser.

Experimental laser welded seams were fabricated using two sheets of a commercially available conductive (black) carbon-loaded polycarbonate material, 102 micrometers thick, purchased from Gunze Limited, Japan, coated with Stat-Rite E1150 polyurethane, purchased from Lubrizol and coated to a thickness of 380 micometers. The two sheets to be attached were 3″ long and 2″ wide, the edges of which were cut or tapered at angles varying between 45 and 90 degrees and were butted together over a gas absorbing layer of polyethylene terephthalate (PET), 118 micrometers thick. The polyurethane side of each sheet was placed face down on top of the PET gas absorbing layer and then placed over a quartz glass block. Another quartz block was placed on top of the polycarbonate side of each sheet. The glass block underneath the PET was mounted on an aluminum block resting on a piston that applied pressure upwards against the entire assembly that was supported by a metal structure. Pressures were varied between 20 and 95 pounds per square inch. Two pieces of paper were placed on the upper glass block flanking each side of the abutting two sheets. They were placed from 0.25″to 0.50″ apart. This spacing controlled the distance on each side of the seam that would be exposed to the laser. It was found that 0.375″ gave the best results. The laser was a diode device attached to multiple fiber optic bundles terminating in thin tubes mounted 0.5″ above the upper glass block and traversed over the abutting sheets. The laser traversing speed was varied from 6 to 50 inches per minute. Power to the laser could be controlled from 0 to 100% in a single or multiple channel arrangement. In a single channel arrangement, 100% power was ideal. For longer lengths approximating a full width belt of roughly 400 mm, the power was stepped with 100% power going to the first channel, 80% to the second, 60% to the third, and 50% to the remaining two channels. It is surmised that full power to the first channel applied enough heat to begin melting the polycarbonate layer while the heat applied to the remaining channels melted the polyurethane layer, allowing the trapped gases to escape at a rate that resulted in a smooth seam with no bubbles present. Unsatisfactory seam quality was obtained with the use of 100% power for each channel when welding a long seam. It is believed the sheets are subjected to excessive heat as each channel of the laser passes over the first channel, causing a distorted weld as well as bubbles that cannot escape quickly enough before they are trapped. It will be appreciated that alternative laser energy profiles, such as operating the laser at a lower power for the first channel and stepping the laser power higher with subsequent channels, may be beneficial for laser welding of different materials.

Welded seam strength was tested on an MTS Load Frame and the failure load was equivalent to the bulk material, indicating very high seam tear strength. Both 90 and 45 degree edge cuts resulted in excellent welds.

The invention has been described in detail with particular reference to certain preferred embodiments thereof, but it will be understood that variations and modifications can be effected within the scope of the invention.

### PARTS LIST

2 load application device
4 support
6 first rigid plate
8 gas absorbing layer
10 first sheet
11 second sheet
12 second rigid plate
14 laser
15 laser energy absorbing material
17 aperture
50 first sheet
52 first layer
54 second layer
60 second sheet
62 first layer
64 second layer
80 endless belt
82 seam
83 rollers
84 rollers

1. A method for joining a first sheet to a second sheet comprising:
providing a first rigid plate;
providing a thermal conductive layer consisting of a material selected from polyethylene terephthalate (PET), polyimide, or polycarbonate on the first rigid plate;
positioning the first sheet, wherein the first sheet has at least a first layer and a second layer, on the thermal conductive layer;
positioning the second sheet, wherein the second sheet has at least a first layer and a second layer, on the thermal conductive layer;
wherein an edge of the first sheet abuts an edge of the second sheet;
placing a second rigid plate on top of the first and second sheet;
wherein the second rigid plate is transparent;
applying pressure to the first sheet edge and second sheet edge; and
laser welding the edge of the first sheet to the edge of the second sheet with a first laser through the second rigid plate.

2. The method of claim 1 wherein the first and second rigid plates are glass.

3. The method of claim 2 wherein a second laser welds the edge of the first sheet to the edge of the second sheet through the first rigid plate.

4. The method of claim 1 wherein the first and second rigid plates are thermal insulators.

5. The method of claim 1 wherein the first edge and the second edge are tapered at an angle.

6. The method of claim 1 wherein the first laser comprises a laser connected to a plurality of radiation conducting fibers.

7. The method of claim 6 further comprising:
operating a first laser in the plurality at a first power at full power to preheat the edge; and
operating a second laser in the plurality at a second power less than the first power.

8. The method of claim 6 further comprising:
operating a first laser in the plurality at a first power less than full power to preheat the edge; and
operating a second laser in the plurality at a second power greater than the first power.

9. The method of claim 1 wherein the first laser is a laser diode array.

10. The method of claim 1 wherein the first layer of the first and second sheet is selected from a group consisting of thermoplastics including polycarbonate, polyimide, polyamide, PET, PEN, PETG, loaded with a laser energy absorbent materials such as carbon or an infrared absorbing dye or pigment.

11. The method of claim 1 wherein the second layer of the first and second sheet is selected from a group consisting of thermoplastic elastomers including polyurethanes, styrenic block copolymers, or EPDM.

12. The method of claim 1 wherein the first and second sheets have a third layer comprising a release layer.

13. The method of claim 1 wherein the pressure applied is between 20 and 95 psi.

14. The method of claim 1 wherein at least one layer absorbs the laser energy and converts it to heat.

15. The method of claim 1 wherein the first sheet and the second sheet form a belt after joining the edge of the first sheet to the edge of the second sheet.

16. A method for joining a first sheet to a second sheet comprising:
providing a first rigid plate;
providing a thermal conductive layer consisting of a material selected from polyethylene terephthalate (PET), polyimide, or polycarbonate on the first rigid plate;
positioning a first sheet having a polycarbonate layer and a polyurethane layer on the thermal conductive layer;
wherein the polyurethane layer is adjacent to the thermal conductive layer;
positioning a second sheet having a polycarbonate layer and a polyurethane layer on the thermal conductive layer;
wherein the polyurethane layer is adjacent to the thermal conductive layer;
wherein an edge of the of the first sheet abuts an edge of the second sheet;
placing a second rigid plate of transparent material on top of the first and second sheet;
applying pressure to the first and second sheet; and
laser welding the edge of the first sheet to the edge of the second sheet with a first laser.

17. A method for joining a first sheet to a second sheet comprising:
providing a first rigid plate;
providing a thermal conductive layer consisting of a material selected from polyethylene terephthalate (PET). polyimide, or polycarbonate on the first rigid plate;
positioning the first sheet on the thermal conductive layer;
positioning the second sheet on the thermal conductive layer; wherein an edge of the of the first sheet abuts an edge of the second sheet;
providing a layer of laser energy absorbing material on the first and second sheet;
placing a second rigid plate, wherein the second rigid plate is comprised of transparent material, on top of the first and second sheets;
applying pressure to the first sheet edge and second sheet edge; and
laser welding the edge of the first sheet to the edge of the second sheet with a first laser.
